(19) United States
(12) Patent Application Publication
(10) Pub. No.: US 2023/0353542 A1
(43) Pub. Date: Nov. 2, 2023

(54) TRANSPORTER SYSTEM

(71) Applicant: VMware, Inc., Palo Alto, CA (US)

(72) Inventors: John KILROY, Portsmouth, NH (US); Glenn Bruce MCELHOE, Arlington, MA (US); Steve JONES, Atlanta, GA (US); Ryan BRADFORD, Melrose, MA (US); Patrick PERALTA, Burlington, MA (US)

(21) Appl. No.: 17/661,597

(22) Filed: May 2, 2022

(51) Int. Cl. H04L 9/40

(52) U.S. Cl. CPC H04L 63/0281; H04L 63/0272; H04L 63/10

(57) ABSTRACT

The disclosure provides an approach for inter-network resource connectivity. Embodiments include receiving, by a forward proxy of a transporter server, from a device in a source network, a request directed to a resource in a target network. Embodiments include forwarding the request to a reverse proxy of the transporter server, wherein the forward proxy and the reverse proxy of the transporter server are not in the target network. Embodiments include transmitting the request from the reverse proxy to a transporter client in the target network via a first tunnel channel. Embodiments include transmitting the request from the transporter client to the resource in the target network via a second tunnel channel. Embodiments include returning a response to the device based on the request via the second tunnel channel, the first tunnel channel, the reverse proxy, and the forward proxy.

### RELATED APPLICATIONS

The subject matter of the present patent application is related to pending U.S. patent application Ser. No. 17/581,955, filed on Jan. 23, 2022, the contents of which are herein incorporated in their entirety by reference for all purposes.

### BACKGROUND

In recent years, enterprises have started to move some of their computer and network resources to clouds, while maintaining other resources in private datacenters. This has resulted in a proliferation of the number of clouds and the type of services offered by these clouds. This, in turn, has caused many enterprises to have several different deployments in several different clouds. Deployments across many different clouds offer many advantages, but increase the complexity of configuring the cloud resources' access to on-premises resources in the private datacenters of enterprises.

Providing access to resources such as applications in a first network (e.g., data center or cloud) to entities in a second network (e.g., data center or cloud) is difficult to achieve in an effective and secure manner. Accordingly, there is a need in the art for improved techniques for inter-network resource connectivity.

### BRIEF DESCRIPTION OF THE DRAWINGS

FIG. 1 illustrates an example related to inter-network resource connectivity.

FIG. 2 illustrates another example related to inter-network resource connectivity.

FIG. 3 illustrates an example of physical and virtual computing components with which embodiments of the present disclosure may be implemented.

FIG. 4 depicts example operations related to inter-network resource connectivity.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for inter-network resource connectivity. For example, embodiments described herein allow for securely connecting applications to resources across clouds and/or data centers with minimal administrative overhead and no requirement to configure external inbound connectivity in the target cloud or data center (e.g., the cloud or data center in which the resource being accessed is located). In particular, a Transporter system (or, more generally, a transporter system) as described herein enables an application to submit a request through the described components to a target resource that is otherwise inaccessible to the application (e.g., because of network and security constraints). The initiating application, which may be referred to herein as an initiator, may be in a separate cloud or data center from the target resource. The target resource may, for example, be an application, a function provided by an application, data, a physical computing resource, and/or the like. In some embodiments, the target resource is internal to the target cloud or data center, while in other embodiments the target resource is outside the target cloud or data center but reachable from the target cloud or data center.

According to certain embodiments, a Transporter system is made up of software components including a Transporter server with a forward proxy and a reverse proxy and a Transporter client that is located in the same cloud or data center as the target resource and connects to the reverse proxy of the Transporter server. The Transporter server may be in the same cloud or data center as the initiator or may be in a different location (e.g., different network). The initiator may send a request to access the resource to the forward proxy of the Transporter server, and the request may be forwarded to the reverse proxy and then relayed by the reverse proxy to the Transporter client. The Transporter client has a connection to the resource, and may send the request to the resource. The resource may then respond to the request, and the response may be sent back through the Transporter client, reverse proxy, and forward proxy to the initiator. It is noted that the reverse proxy does not initiate a connection to the Transporter client. Rather, the Transporter client initiates the command channel connection to the Transporter server, and bi-directional message exchanges over this command channel facilitate the handling of initiator requests.

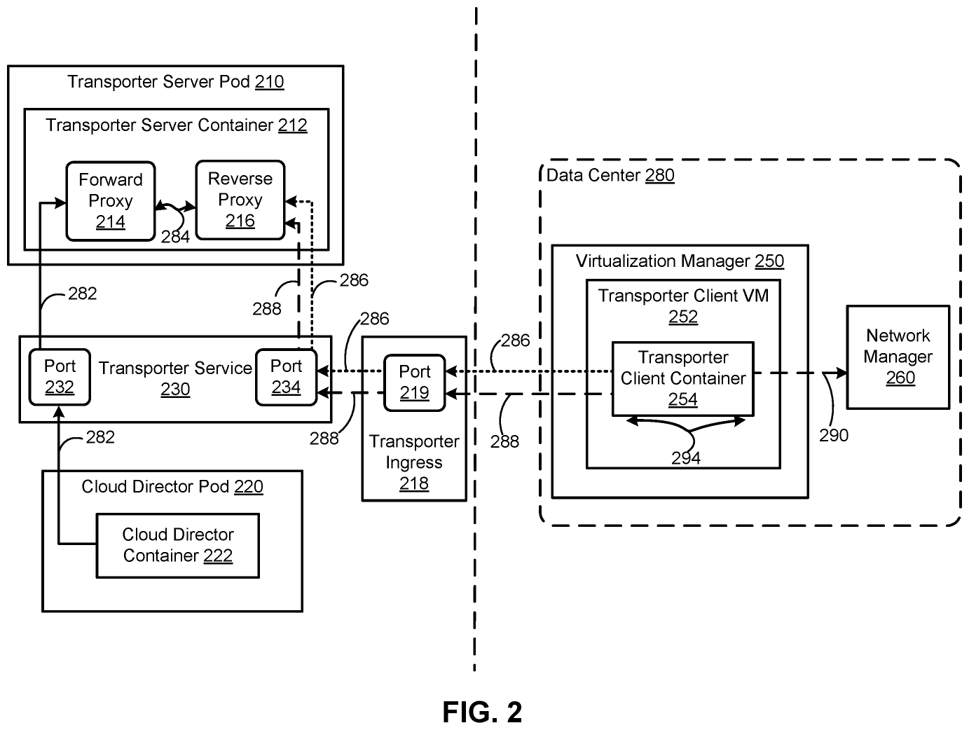

As described in more detail below with respect to FIG. 2, a forward proxy is generally used to pass requests from an isolated, private network to an external endpoint (e.g., via the internet) through a firewall. A reverse proxy generally refers to a component that sits in front of a server and forwards client requests to that server. Reverse proxies are typically implemented to help increase security, performance, and reliability. In the present case, a combination of a forward proxy and a reverse proxy is used so that requests can be sent to the forward proxy from an initiator in a source cloud or data center while security of the target resource is maintained by the use of the reverse proxy that controls access to the Transporter client in the target cloud or data center. The Transporter server's forward proxy and reverse proxy are outside of the target cloud or data center, which allows the Transporter server to potentially route proxy requests to resources in multiple target clouds and/or data centers via one or more reverse proxies. As such, techniques described herein provide improved scalability over techniques in which a forward proxy and/or reverse proxy are located in the target cloud or data center. Furthermore, techniques described herein allow inter-network resource connectivity without requiring separate configuration of the target resource or the initiator for such connectivity. For example, by providing a Transporter client that can be easily deployed (e.g., from an image) in a target networking cloud or data center, there is no need to perform additional configuration in the target cloud or data center or to set up a reverse proxy in the target cloud or data center.

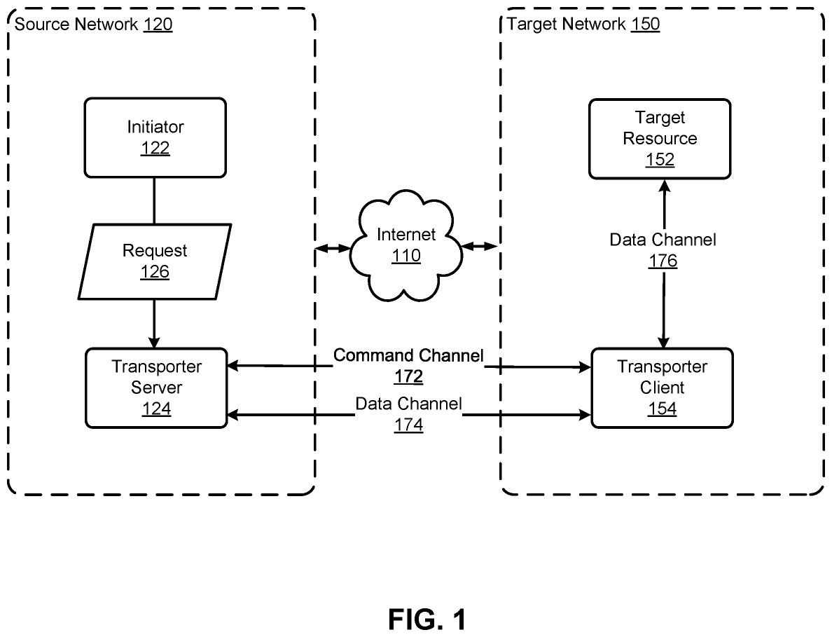

FIG. 1 illustrates an example related to inter-network resource connectivity.

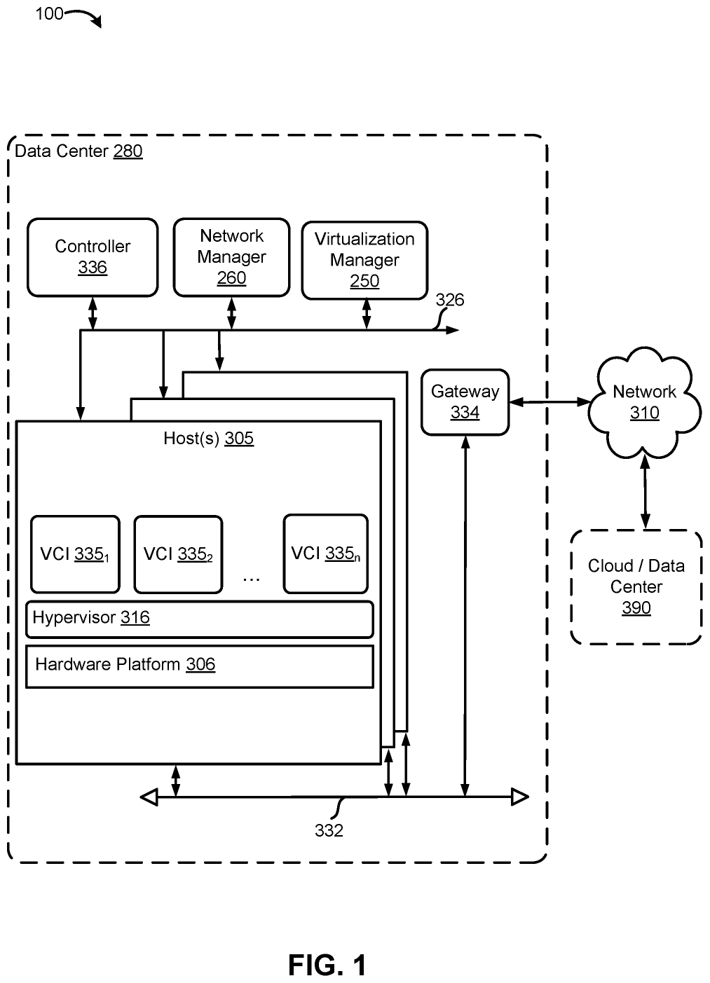

In FIG. 1, a source network 120 is connected to a target network 150 via the Internet 110. Source network 120 and target network 130 may, for example, be clouds or data centers. For example, as described in more detail below with respect to FIG. 3, target network 150 may be a software-defined data center (SDDC) and source network 120 may be a public cloud. While the Internet 110 is included as an example, source network 120 and target network 150 may alternatively be connected by a different type of network.

An initiator 122 is located in source network 120, and generally represents an application that initiates a request 126 to access a target resource 152 in target network 150. In an example, as described in more detail below with respect to FIG. 2, initiator 122 is a cloud director, which is a software component that manages allocation of virtual computing resources to an enterprise for deploying applications. An example of a cloud director is VMWare® Cloud Director®. Target resource 152 may, for example, be a management component of an SDDC, such as a virtualization manager and/or network manager that perform management functions with respect to virtual computing instances (VCIs), allocation of physical computing resources, virtual networks, and/or the like. For instance, request 126 may be a request to a network manager of target network 150 to retrieve a list of virtual networks associated with target network 150.

Transporter server 124 is located in source network 120, and generally comprises a software component that is connected to a Transporter client 154 in target network 150, and allows connectivity between initiators in source network 120 and resources located in and/or accessible from target network 150. As described in more detail below with respect to FIG. 2, Transporter server 124 may comprise a forward proxy that receives request 126 and a reverse proxy that is connected to Transporter client 154.

Initiator 122 and Transporter server 124 may run on one or more physical computing devices comprising memory, one or more processors, and the like.

Transporter client 154 establishes a command channel 172 with Transporter server 124. Command channel 172 is a secure communication channel for transmission of commands and/or other communications between Transporter client 154 and Transporter server 124. In one example, command channel 172 is established using a WebSocket secure (WSS) protocol. WSS protocol connections are initiated over hypertext transfer protocol (HTTP) and are typically long-lived such that messages can be sent in either direction at any time and are not transactional in nature. A WSS connection will typically remain open and idle until either the client or the server is ready to send a message.

When Transporter server 124 receives request 126, Transporter server 124 issues a command via command channel 172 to Transporter client 154 to prepare to handle request 126 (which is directed to target resource 152). Transporter client 154 processes this command by creating a connection to target resource 152, thus forming data channel 176, and another connection back to Transporter server 124, thus forming data channel 174.

In certain embodiments, command channels and data channels are both initially WSS connections. However, one difference between a command channel and a data channel is that a command channel remains a WSS connection for its lifetime whereas a data channel, while it is initially a WSS connection, subsequently becomes a basic socket channel over which uninterpreted bytes are sent. Another difference between a command channel and a data channel is that a data channel is created on a per-request basis, while a command channel is long-lived (e.g., not being associated with any one request). As such, if an initiator sends a request to the Transporter server, the Transporter server will use the command channel to request a data channel to handle the current request. The data channel may exist for the duration of the initiator's request, after which the data channel may be promptly destroyed.

Transporter client 154 may send a command to Transporter server 124 indicating that the data path for fulfilling request 126 has been created. The data path represented by data channels 174 and 176 may be specific to request 126, while command channel 172 may not be specific to any one request. Command channel(s) are primarily responsible for orchestrating the creation of data paths (which include data channels between the Transporter client and server) to the target resources in response to initiator requests. A request's data path, which includes its dedicated data channel, typically lasts only for the duration of the request, whereas command channels persist as long as the client is connected to the server.

Request 126 may be sent to Transporter client 154 via data channel 174 and then to target resource 152 via data channel 176. A response to request 126 may then be sent back from target resource 152 to Transporter client 154 via data channel 176, sent from Transporter client 154 to Transporter server 124 via data channel 174, and then returned to initiator 122 via the forward proxy of Transporter server 124. For example, the response may be a requested list of virtual networks associated with target network 150.

Target resource 152 and Transporter client 154 may run on one or more physical computing devices comprising memory, one or more processors, and the like.

It is noted that while certain types of initiators, requests, and target resources are described herein as examples, these examples are not limiting and other types of initiators, requests, and target resources are possible. Furthermore, while certain architectural arrangements and locations of components are described herein, other arrangements and locations are possible.

FIG. 2 illustrates another example related to inter-network resource connectivity.

A Transporter server pod 210 comprises a Transporter server container 212 with a forward proxy 214 and a reverse proxy 216. Transporter server pod 210 represents a non-limiting example implementation of Transporter server 124 of FIG. 1. A pod is a logical construct that generally includes multiple containers, such as a main container and one or more sidecar containers, which are responsible for supporting the main container. For example, Transporter server container 212 may be a main container of Transporter server pod 210, and one or more additional containers (not shown) may provide support functions such as logging and/or data storage for Transporter server container 212. While a single pod is shown, a service deployment may include one or more pods, individual containers, VMs, and/or other VCIs. In one embodiment, Transporter server pod 210 is implemented as a platform as a service (PAAS) or container as a service (CAAS) object such as, for example, a Kubernetes® object.

Transporter server container 212 comprises a forward proxy 214 and a reverse proxy 216, which are servers (e.g., implemented as software components within Transporter server container 212). Forward proxy 212 sits in front of one or more clients (e.g., initiators such as cloud director container 222) and ensures that no target resource (e.g., network manager 260) ever communicates directly with that specific client. Reverse proxy 216 sits in front of a target resource (e.g., network manager 260) and ensures that no client (e.g., cloud director container 222) ever communicates directly with that target resource. It is noted that while a single reverse proxy 216 is shown, Transporter server container 212 may comprise a plurality of reverse proxies associated with different target resources in one or more networking environments.

A Transporter service 230 and a Transporter ingress 218 are associated with Transporter server pod 210. For example, Transporter service 230 and Transporter ingress 218 may be artifacts that are deployed as a consequence of the deployment of Transporter server pod 210. Transporter service 230 comprises an inbound port 232 and an outbound port 234, which allow for communication to and from Transporter server pod 210. Transporter ingress 218 comprises a port 219 that allows for communication between Transporter server pod 210 and endpoints in separate networking environments, such as Transporter client container 254 in data center 280.

Cloud director pod 220 comprises cloud director container 222, and generally represents a deployment of a cloud director that manages allocation of virtual computing resources to an enterprise for deploying applications. Cloud director pod 220 may be located in the same cloud or data center as the Transporter server or may be in a different location.

Transporter server pod 210, Transporter server container 212, Transporter service 230, Transporter ingress 218, cloud director pod 220, and/or cloud director container 222 may run on one or more physical computing devices comprising memory, one or more processors, and the like.

As described in more detail below with respect to FIG. 3, data center 280 represents an SDDC that comprises VCIs running on one or more physical host machines, and includes one or more management components that provide management functionality with respect to VCIs and/or networks. For example, data center 280 includes a virtualization manager 250 and a network manager 260, each of which may run as one or more VCIs in data center 280.

Transporter client VM 252 runs within virtualization manager 250, and represents an implementation of Transporter client 154 of FIG. 1. Transporter client VM 252 comprises a Transporter client container 254. For example, the Transporter client may be installed as a docker container or directly as a VM. In some embodiments, the Transporter client is deployed from an image, and does not require additional configuration to be performed on data center 280.

It is noted that while a single Transporter client is depicted, there may be multiple Transporter clients (e.g., in data center 280 and/or in other networking environments) that communicate with a single Transporter server, such as via one or more reverse proxies of the Transporter server.

The directions of the arrows of channels 282, 286, 288, and 290 indicate the directions in which the connections are established, and data may flow in both directions via these channels (e.g., the arrows do not mean that these are one-way channels). A command channel 286 is established between Transporter client container 254 and reverse proxy 216 via port 219 of Transporter ingress 218 and port 234 of Transporter service 230. For example, Transporter client container 254 may initiate a connection to reverse proxy 216, and command channel 286 may be stablished via WSS protocol. For instance, Transporter client container 254 may initiate the connection via a call to an application programming interface (API) method provided by the Transporter server, and provides an API token with the call so that the Transporter server can authenticate the token. In some embodiments, command channel 286 includes a secure sockets layer (SSL) connection that terminates at Transporter ingress 218.

Cloud director container 222 sends a request to forward proxy 214 via port 232 to access a function of network manager 260 in data center 280, thereby establishing proxy channel 282. Transporter server container 212 determines that command channel 286 corresponds to the data center 280 in which the target resource of the request is located, and sends a connect request to the Transporter client container 254 via command channel 286. Transporter client container 254 then initiates a new connection to reverse proxy 216 for handling data related to the request, thereby establishing tunnel channel 288 via port 219 of Transporter ingress 218 and port 234 of Transporter service 230. Transporter client container 254 also establishes tunnel channel 290 with network manager 260 for servicing the request.

Cross-wiring may be performed (e.g., cross wiring 284 and 294) to ensure that data flows between forward proxy 214 and reverse proxy 216, as well as between tunnel channels 290 and 288. For example, cross-wiring 284 causes reads on forward proxy 214 to become writes on reverse proxy 216, and vice versa. Similarly, cross-wiring 294 may cause reads on tunnel channel 288 to become writes on tunnel channel 290, and vice versa.

As such, a complete path for handling this particular request is established between cloud director container 222 and network manager 260, comprising proxy channel 282, tunnel channel 288, and tunnel channel 290. In some embodiments, the Transporter server and/or the Transporter client may store information about these channels in a tunnel map, such as mapping a tunnel identifier to identifying information of proxy channel 282, tunnel channel 288, and/or tunnel channel 290.

For example, if the request from cloud director container 222 is a request for a list of virtual networks provided by network manager 260, then the request may be sent to network manager 160 via proxy channel 282 and tunnel channels 288 and 290, and the list of virtual networks may be returned to cloud director container 222 via tunnel channels 290 and 280 and proxy channel 282.

FIG. 3 depicts example physical and virtual network components with which embodiments of the present disclosure may be implemented.

Networking environment 300 includes data center 280 of FIG. 2 connected to network 310. Network 310 is generally representative of a network of machines such as a local area network (“LAN”) or a wide area network (“WAN”), a network of networks, such as the Internet (e.g., Internet 110 of FIG. 1), or any connection over which data may be transmitted.

Data center 280 generally represents a set of networked machines and may comprise a logical overlay network. Data center 280 includes host(s) 305, a gateway 334, a data network 332, which may be a Layer 3 network, and a management network 326. Host(s) 305 may be an example of machines. Data network 332 and management network 326 may be separate physical networks or different virtual local area networks (VLANs) on the same physical network. Data center 280 may correspond to target network 150 of FIG. 1.

Cloud or data canter 390 is also connected to network 310, and may have component similar to those depicted in data center 280 and/or additional components. Cloud and/or data center 390 may correspond to source network 120 of FIG. 1. In some embodiments, cloud or data center 390 comprises cloud director pod 220, Transporter server pod 210, and/or Transporter service 230 of FIG. 2.

It is noted that, while not shown, additional networking environments such as data centers and/or clouds may also be connected to network 310. Communication between the different data centers and/or clouds may be performed via gateways or corresponding components associated with the different data centers and/or clouds.

Each of hosts 305 may include a server grade hardware platform 306, such as an x86 architecture platform. For example, hosts 305 may be geographically co-located servers on the same rack or on different racks. Host 305 is configured to provide a virtualization layer, also referred to as a hypervisor 316, that abstracts processor, memory, storage, and networking resources of hardware platform 306 for multiple virtual computing instances (VCIs) 335i to 335n (collectively referred to as VCIs 335 and individually referred to as VCI 335) that run concurrently on the same host. VCIs 335 may include, for instance, VMs, containers, virtual appliances, and/or the like. VCIs 335 may be an example of machines. In certain embodiments, Transporter client VM 252 and/or Transporter client container 254 of FIG. 2 may be included in VCIs 335.

In certain aspects, hypervisor 316 may run in conjunction with an operating system (not shown) in host 305. In some embodiments, hypervisor 316 can be installed as system level software directly on hardware platform 306 of host 305 (often referred to as “bare metal” installation) and be conceptually interposed between the physical hardware and the guest operating systems executing in the virtual machines. It is noted that the term “operating system,” as used herein, may refer to a hypervisor. In certain aspects, hypervisor 316 implements one or more logical entities, such as logical switches, routers, etc. as one or more virtual entities such as virtual switches, routers, etc. In some implementations, hypervisor 316 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Gateway 334 provides VCIs 335 and other components in data center 330 with connectivity to network 310, and is used to communicate with destinations external to data center 330, such as cloud or data center 390. Gateway 334 may be implemented as one or more VCIs, physical devices, and/or software modules running within one or more hosts 305.

Controller 336 generally represents a control plane that manages configuration of VCIs 335 within data center 330. Controller 336 may be a computer program that resides and executes in a central server in data center 330 or, alternatively, controller 336 may run as a virtual appliance (e.g., a VM) in one of hosts 305. Although shown as a single unit, it should be understood that controller 336 may be implemented as a distributed or clustered system. That is, controller 336 may include multiple servers or virtual computing instances that implement controller functions. Controller 336 is associated with one or more virtual and/or physical CPUs (not shown). Processor(s) resources allotted or assigned to controller 336 may be unique to controller 336, or may be shared with other components of data center 330. Controller 336 communicates with hosts 305 via management network 326.

Network manager 260 and virtualization manager 250 of FIG. 2 are also included in data center 280, and represent a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In one embodiment, network manager 260 and virtualization manager 250 are computer programs that execute in a central server in networking environment 300, or alternatively, may run in one or more VMs, e.g. in one or more of hosts 305. Network manager 260 is configured to receive inputs from an administrator or other entity, e.g., via a web interface or API, and carry out administrative tasks for data center 280, including centralized network management and providing an aggregated system view for a user. In some embodiments, virtualization manager 250 is an application that provides an interface to hardware platform 306. A virtualization manager is configured to carry out various tasks to manage virtual computing resources. For example, a virtualization manager can deploy VCIs in data center 280 and/or perform other administrative tasks with respect to VCIs.

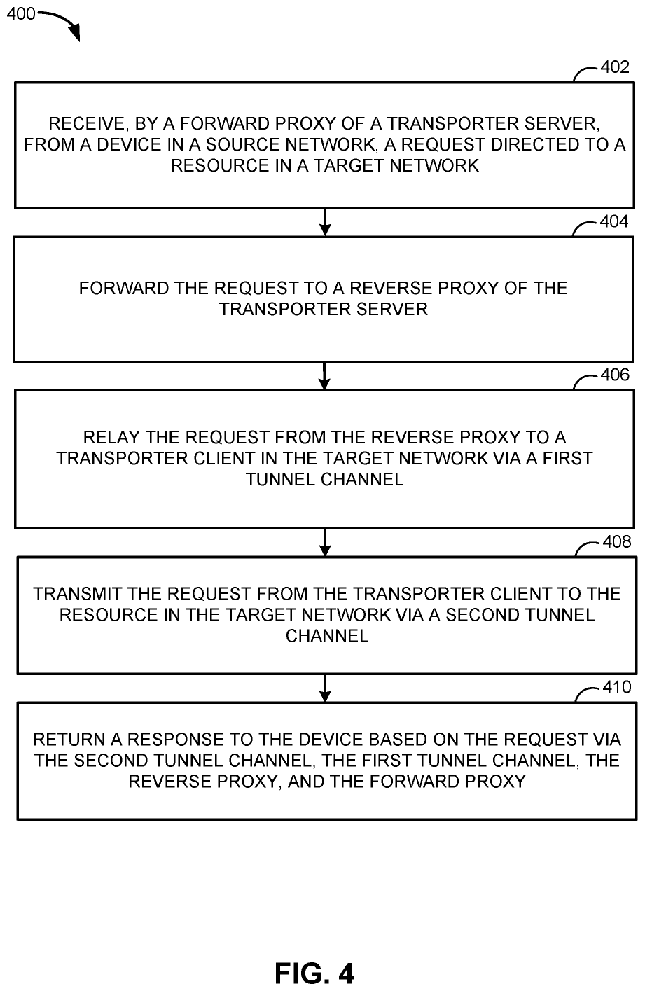

FIG. 4 depicts example operations 400 related to inter-network resource connectivity. For example, operations 400 may be performed by one or more components of source network 120 and/or target network 150 of FIG. 1 and/or one or more of the components described with respect to FIGS. 2 and 3.

Operations 400 begin at step 402, with receiving, by a forward proxy of a Transporter server, from a device in a source network, a request directed to a resource in a target network. For example, the resource may comprise a management component related to the target network, and the request may relate to a management function provided by the management component

Certain embodiments further comprise establishing a proxy channel between the device and the forward proxy.

Operations 400 continue at step 404, with forwarding the request to a reverse proxy of the Transporter server. For example, the forward proxy and the reverse proxy of the Transporter server may not be in the target network

In some embodiments, the Transporter server comprises a plurality of reverse proxies including the reverse proxy, and each of the plurality of reverse proxies is connected to a respective Transporter client of a plurality of Transporter clients, the plurality of Transporter clients including the Transporter client.

Operations 400 continue at step 406, with transmitting the request from the reverse proxy to a Transporter client in the target network via a first tunnel channel.

Operations 400 continue at step 408, with transmitting the request from the Transporter client to the resource in the target network via a second tunnel channel.

Some embodiments further comprise storing information related to the proxy channel, the first tunnel channel, and the second tunnel channel in tunnel mapping information, such as associating a tunnel identifier with the information related to the proxy channel, the first tunnel channel, and the second tunnel channel in the tunnel mapping information. In certain embodiments the tunnel identifier is unique to the request.

Operations 400 continue at step 410, with returning a response to the device based on the request via the second tunnel channel, the first tunnel channel, the reverse proxy, and the forward proxy.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of inter-network resource connectivity, comprising:
receiving, by a forward proxy of a transporter server, from a device in a source network, a request directed to a resource in a target network;
forwarding the request to a reverse proxy of the transporter server, wherein the forward proxy and the reverse proxy of the transporter server are not in the target network;
transmitting the request from the reverse proxy to a transporter client in the target network via a first tunnel channel;
transmitting the request from the transporter client to the resource in the target network via a second tunnel channel; and
returning a response to the device based on the request via the second tunnel channel, the first tunnel channel, the reverse proxy, and the forward proxy.

2. The method of claim 1, further comprising establishing a proxy channel between the device and the forward proxy.

3. The method of claim 2, further comprising storing information related to the proxy channel, the first tunnel channel, and the second tunnel channel in tunnel mapping information.

4. The method of claim 3, further comprising associating a tunnel identifier with the information related to the proxy channel, the first tunnel channel, and the second tunnel channel in the tunnel mapping information.

5. The method of claim 4, wherein the tunnel identifier is unique to the request.

6. The method of claim 1, wherein the transporter server comprises a plurality of reverse proxies including the reverse proxy, wherein each of the plurality of reverse proxies is connected to a respective transporter client of a plurality of transporter clients, and wherein the plurality of transporter clients includes the transporter client.

7. The method of claim 1, wherein the resource comprises a management component related to the target network, and wherein the request relates to a management function provided by the management component.

8. A system for inter-network resource connectivity, the system comprising:
at least one memory; and
at least one processor coupled to the at least one memory, the at least one processor and the at least one memory configured to:
receive, by a forward proxy of a transporter server, from a device in a source network, a request directed to a resource in a target network;
forward the request to a reverse proxy of the transporter server, wherein the forward proxy and the reverse proxy of the transporter server are not in the target network;
transmit the request from the reverse proxy to a transporter client in the target network via a first tunnel channel;
transmit the request from the transporter client to the resource in the target network via a second tunnel channel; and
return a response to the device based on the request via the second tunnel channel, the first tunnel channel, the reverse proxy, and the forward proxy.

9. The system of claim 8, wherein the at least one processor and the at least one memory are further configured to establish a proxy channel between the device and the forward proxy.

10. The system of claim 9, wherein the at least one processor and the at least one memory are further configured to store information related to the proxy channel, the first tunnel channel, and the second tunnel channel in tunnel mapping information.

11. The system of claim 10, wherein the at least one processor and the at least one memory are further configured to associate a tunnel identifier with the information related to the proxy channel, the first tunnel channel, and the second tunnel channel in the tunnel mapping information.

12. The system of claim 11, wherein the tunnel identifier is unique to the request.

13. The system of claim 8, wherein the transporter server comprises a plurality of reverse proxies including the reverse proxy, wherein each of the plurality of reverse proxies is connected to a respective transporter client of a plurality of transporter clients, and wherein the plurality of transporter clients includes the transporter client.

14. The system of claim 8, wherein the resource comprises a management component related to the target network, and wherein the request relates to a management function provided by the management component.

15. A non-transitory computer-readable medium storing instructions that, when executed by one or more processors, cause the one or more processors to:
receive, by a forward proxy of a transporter server, from a device in a source network, a request directed to a resource in a target network;
forward the request to a reverse proxy of the transporter server, wherein the forward proxy and the reverse proxy of the transporter server are not in the target network;
transmit the request from the reverse proxy to a transporter client in the target network via a first tunnel channel;
transmit the request from the transporter client to the resource in the target network via a second tunnel channel; and
return a response to the device based on the request via the second tunnel channel, the first tunnel channel, the reverse proxy, and the forward proxy.

16. The non-transitory computer-readable medium of claim 15, wherein the instructions, when executed by the one or more processors, further cause the one or more processors to establish a proxy channel between the device and the forward proxy.

17. The non-transitory computer-readable medium of claim 16, wherein the instructions, when executed by the one or more processors, further cause the one or more processors to store information related to the proxy channel, the first tunnel channel, and the second tunnel channel in tunnel mapping information.

18. The non-transitory computer-readable medium of claim 17, wherein the instructions, when executed by the one or more processors, further cause the one or more processors to associate a tunnel identifier with the information related to the proxy channel, the first tunnel channel, and the second tunnel channel in the tunnel mapping information.

19. The non-transitory computer-readable medium of claim 18, wherein the tunnel identifier is unique to the request.

20. The non-transitory computer-readable medium of claim 15, wherein the transporter server comprises a plurality of reverse proxies including the reverse proxy, wherein each of the plurality of reverse proxies is connected to a respective transporter client of a plurality of transporter clients, and wherein the plurality of transporter clients includes the transporter client.
